(19) United States
(12) Patent Application Publication
(10) Pub. No.: US 2022/0226889 A1
(43) Pub. Date: Jul. 21, 2022

(54) FLUID HEATING FURNACE AND HEATING METHOD

(71) Applicant: TOYOTA JIDOSHA KABUSHIKI KAISHA, Toyota-shi (JP)

(72) Inventors: Daisuke YAMASHITA, Toyota-shi (JP); Hirotsune WATANABE, Miyoshi-shi (JP)

(73) Assignee: TOYOTA JIDOSHA KABUSHIKI KAISHA, Toyota-shi (JP)

(21) Appl. No.: 17/528,531

(22) Filed: Nov. 17, 2021

(30) Foreign Application Priority Data
Jan. 21, 2021 (JP) 2021-007847

(51) Int. Cl. B22D 29/00; B22C 5/08

(52) U.S. Cl. CPC B22D 29/003; B22C 5/085

(57) ABSTRACT

A fluid heating furnace is a fluid heating furnace for recycling core sand used for a core. The fluid heating furnace includes: a fluid tank in which the core sand is heated by flowing gas while the core sand is caused to flow by the flowing gas; and a gas discharge passage communicating with the fluid tank such that the flowing gas is discharged through the gas discharge passage. The gas discharge passage includes an inlet portion via which the core sand is put into the fluid tank through the gas discharge passage. In the gas discharge passage, the flowing gas discharged through the gas discharge passage heats the core sand put into the gas discharge passage from the inlet portion, and in the fluid tank, the core sand heated in the gas discharge passage is further heated.

### CROSS-REFERENCE TO RELATED APPLICATION

This application claims priority to Japanese Patent Application No. 2021-007847 filed on Jan. 21, 2021, incorporated herein by reference in its entirety.

### BACKGROUND

### 1. Technical Field

The present disclosure relates to a fluid heating furnace and a heating method.

### 2. Description of Related Art

Japanese Unexamined Patent Application Publication No. 2013-146741 (JP 2013-146741 A) describes such a technology that sand (hereinafter referred to as “core sand”) used for a core used in casting is collected so that the core sand is reused by removing impurities and a binder attached to the core sand. More specifically, JP 2013-146741 A describes the following technology. That is, a casting product cast by use of a metal die including a core is subjected to a heat treatment at 500° C. so as to roast an organic binder covering the surface of the core, so that the core is broken. Hereby, core sand from which the organic binder is removed to some extent is collected.

### SUMMARY

In recent years, in order to prevent nicotine, soot, a bad smell (gas), or the like that occurs when an organic binder used for a core is heated in a casting process, a core formed by use of an inorganic binder such as water glass has been used. In a case where core sand is recycled from the core formed by use of the inorganic binder, the inorganic binder is also removed from the core sand by heating. In order to prevent the inorganic binder from solidifying again in a heating furnace, a fluid tank in which the core sand is heated by flowing gas while the core sand is caused to flow by the flowing gas is required. A heating furnace configured such that heating is performed in such a fluid tank is referred to as a fluid heating furnace. A high-temperature discharge gas is caused in the fluid heating furnace, and therefore, the fluid heating furnace has such a problem that its heat efficiency is low.

The present disclosure is accomplished in order to solve such a problem, and an object of the present disclosure is to provide a fluid heating furnace and a heating method each of which is improved in heat efficiency.

A fluid heating furnace according to the present disclosure is a fluid heating furnace for recycling core sand used for a core. The fluid heating furnace includes a fluid tank and a gas discharge passage. In the fluid tank, the core sand is heated by flowing gas while the core sand is caused to flow by the flowing gas. The gas discharge passage communicates with the fluid tank such that the flowing gas is discharged through the gas discharge passage. The gas discharge passage includes an inlet portion via which the core sand is put into the fluid tank through the gas discharge passage.

A heating method according to the present disclosure is a heating method for heating core sand used for a core by use of a fluid heating furnace including a fluid tank in which the core sand is heated by flowing gas while the core sand is caused to flow by the flowing gas. The fluid heating furnace further includes a gas discharge passage communicating with the fluid tank such that the flowing gas is discharged through the gas discharge passage. The gas discharge passage includes an inlet portion via which the core sand is put into the fluid tank through the gas discharge passage. The heating method includes: heating, in the gas discharge passage, the core sand put into the gas discharge passage from the inlet portion by the flowing gas discharged through the gas discharge passage; and further heating, in the fluid tank, the core sand heated in the gas discharge passage.

In the fluid heating furnace and the heating method according to the present disclosure, the core sand from the inlet portion of the gas discharge passage is put into the fluid tank through the gas discharge passage. Accordingly, the core sand is heated by the flowing gas discharged through the gas discharge passage before the core sand reaches the fluid tank. Since heat is transmitted from the fluid gas to the core sand, the heat efficiency of the fluid heating furnace is improved by just that much. Accordingly, it is possible to provide the fluid heating furnace and the heating method each of which is improved in heat efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically illustrating a section of a fluid heating furnace according to Embodiment 1 when the fluid heating furnace is viewed from its lateral side;

FIG. 2 is a perspective view illustrating the inside of a gas discharge passage of the fluid heating furnace according to Embodiment 1;

FIG. 3 is a view illustrating one example of a dispersion plate in the gas discharge passage according to Embodiment 1; and

FIG. 4 is a graph illustrating a sand temperature and a discharge gas temperature in Example 1.

### DETAILED DESCRIPTION OF EMBODIMENTS

### Embodiment 1

With reference to drawings, the following describes Embodiment 1 of the present disclosure. However, the present disclosure is not limited to Embodiment 1. Further, the following description and drawings are simplified appropriately for clarification of the description.

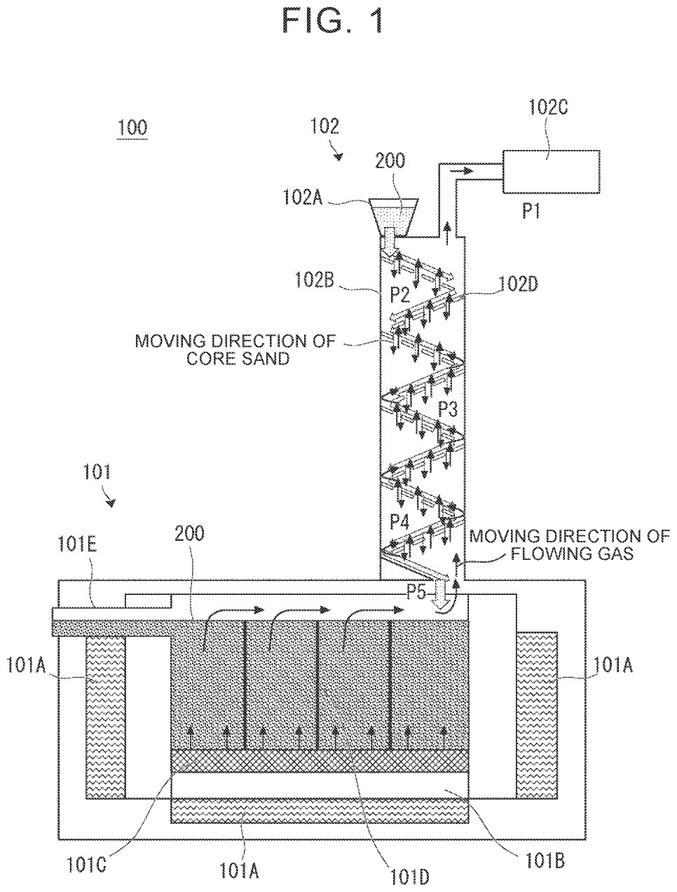

FIG. 1 is a view schematically illustrating a section of a fluid heating furnace 100 according to Embodiment 1 when the fluid heating furnace 100 is viewed from its lateral side. In order to recycle core sand 200 used for a core used in casting, the fluid heating furnace 100 heats the core sand 200. For example, the core used in casting is crushed, so that the core sand 200 is obtained. The fluid heating furnace 100 heats the core sand 200 so as to remove an inorganic binder from the core sand 200, so that the core sand 200 is recycled. As illustrated in FIG. 1, the fluid heating furnace 100 includes a fluid tank 101 and a gas discharge passage 102. The gas discharge passage 102 is provided above the fluid tank 101.

The fluid tank 101 is a heating tank in which the core sand 200 is heated by flowing gas while the core sand 200 is caused to flow by the flowing gas. Here, the flowing gas is gas flowing inside the fluid heating furnace 100. Along with the flowing of the gas, the core sand 200 inside the fluid tank 101 also flows. More specifically, the flowing gas is supplied into the fluid tank 101 from the lower side of the fluid tank 101. The flowing gas rises when the flowing gas is heated in the fluid tank 101, and the flowing gas is discharged outside through the gas discharge passage 102. As illustrated in FIG. 1, the fluid tank 101 includes heaters 101A, an air chamber 101B, a sintered wire mesh 101C, division plates 101D, an outlet portion 101E, and so on.

The heaters 101A are provided on side faces and a bottom face of the fluid tank 101, for example, and heat the core sand 200 inside the fluid tank 101. Further, the heaters 101A heat the flowing gas supplied into the air chamber 101B provided in the lower side of the fluid tank 101. Further, the flowing gas causing the core sand 200 to flow is also heated by the heaters 101A together with the core sand 200 inside the fluid tank 101.

The air chamber 101B is provided on a bottom portion side of the fluid tank 101, and a predetermined gas is supplied from a predetermined gas source (not illustrated) into the air chamber 101B. Further, the upper side of the air chamber 101B communicates with the inside of the fluid tank 101 via the sintered wire mesh 101C. On this account, the gas supplied into the air chamber 101B passes through the sintered wire mesh 101C and moves into the fluid tank 101.

The sintered wire mesh 101C is a metal mesh configured to prevent the core sand 200 from passing from the inside of the fluid tank 101 to the air chamber 101B, the metal mesh having a plurality of hole portions with a size that allows the gas to pass therethrough from the air chamber 101B into the fluid tank 101.

The division plates 101D are plate-shaped members provided in a standing manner inside the fluid tank 101. Further, the division plates 101D are separated from at least one inner wall of the fluid tank 101. The core sand 200 put into the fluid tank 101 is directed toward the outlet portion 101E through a passage of the fluid tank 101, the passage being formed by the division plates 101D.

The outlet portion 101E is a passage from which the core sand 200 is discharged, the passage being provided at a predetermined height in the fluid tank 101, for example. In the example illustrated in FIG. 1, the outlet portion 101E is provided on the upper side of the fluid tank 101.

The gas discharge passage 102 is a passage communicating with the fluid tank 101 and configured such that the flowing gas is discharged from the fluid tank 101 through the passage. The gas discharge passage 102 is provided above the fluid tank 101. The flowing gas turning into an updraft by being heated in the fluid tank 101 is discharged outside the fluid heating furnace 100 through the gas discharge passage 102. As illustrated in FIG. 1, the gas discharge passage 102 includes a tubular main body portion 102B, an inlet portion 102A, a dust collecting device 102C, and so on.

The inlet portion 102A is a container in which a predetermined amount of the core sand 200 can be accommodated and is provided on the upper side of the main body portion 102B. At least part of a bottom portion of the inlet portion 102A is opened, so that the inlet portion 102A communicates with the main body portion 102B. Hereby, the core sand 200 can be put into the fluid tank 101 from the inlet portion 102A through the main body portion 102B.

In the gas discharge passage 102 according to Embodiment 1, the flowing gas discharged through the gas discharge passage 102 heats the core sand 200 put into the gas discharge passage 102 from the inlet portion 102A. Further, in the fluid tank 101, the core sand 200 heated in the gas discharge passage 102 is further heated.

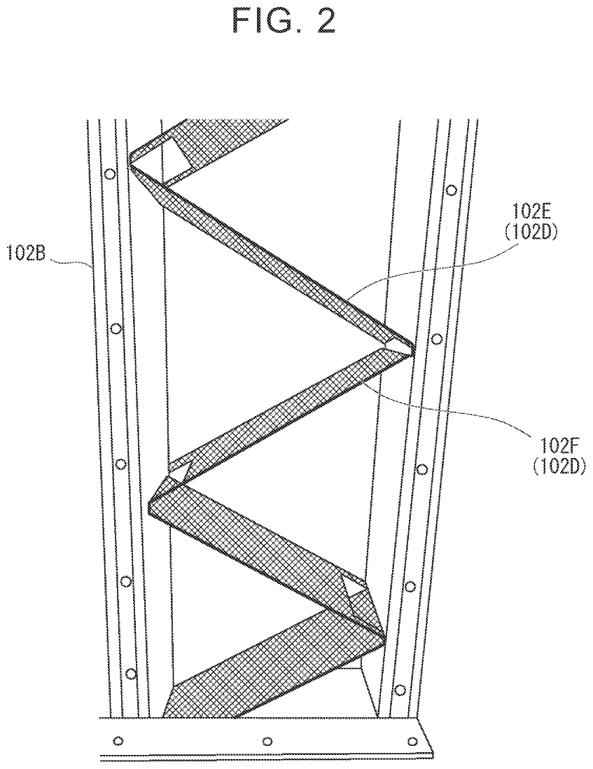

The main body portion 102B is provided in a standing manner above the fluid tank 101 so that the inside of the fluid tank 101 communicates with the inside of the main body portion 102B. FIG. 2 illustrates an example of the inside of the main body portion 102B of the gas discharge passage 102. As illustrated in FIG. 2, the main body portion 102B is an angular pipe having a rectangular section.

Further, one or more dispersion plates 102D are disposed in a bridged manner inside the main body portion 102B in an inclined manner. A plurality of hole portions 102G through which the core sand 200 can pass is formed in the dispersion plates 102D. For example, one or more dispersion plates 102D are disposed in a bridged manner inside the main body portion 102B such that the dispersion plates 102D are inclined at a predetermined angle from an inner wall on a first side toward an inner wall on a second side in the main body portion 102B. Since the core sand 200 put in from the inlet portion 102A is dispersed by the dispersion plates 102D, the contact area of the core sand 200 with the flowing gas passing through the main body portion 102B increases, so that efficiency of heat exchange between the core sand 200 and the flowing gas improves.

More specifically, as illustrated in FIG. 1, the flowing gas flowing from the fluid tank 101 into the main body portion 102B rises inside the main body portion 102B along the dispersion plates 102D. In the meantime, the core sand 200 put into the main body portion 102B from the inlet portion 102A falls along the dispersion plates 102D and falls on the dispersion plate 102D on the lower side through the hole portions 102G provided in the dispersion plates 102D. As such, due to the dispersion plates 102D, the core sand 200 falling down in a dispersed manner makes contact with the flowing gas rising along the dispersion plates 102D, so that heat exchange is performed between the flowing gas and the core sand 200.

Further, the dispersion plates 102D are inclined in different directions. For example, as illustrated in FIG. 2, the dispersion plates 102D include first dispersion plates 102E inclined downward from the inner wall on the first side to the inner wall on the second side in the main body portion 102B, and second dispersion plates 102F inclined upward from the inner wall on the first side to the inner wall on the second side in the main body portion 102B.

Further, the dispersion plates 102D inclined in different directions are disposed in a bridged manner inside the main body portion 102B. For example, the first dispersion plates 102E and the second dispersion plates 102F are alternately disposed in a bridged manner over the inner walls of the main body portion 102B.

When the dispersion plates 102D are placed as such, the core sand 200 is further dispersed, so that efficiency of heat exchange between the core sand 200 and the flowing gas further improves.

Further, it is preferable that the dispersion plates 102D be disposed in a bridged manner over the inner walls of the main body portion 102B at an angle (an angle at which the dispersion plates 102D are inclined) equal to or more than an angle of rest of the core sand 200. Hereby, it is possible to prevent the core sand 200 from staying on the dispersion plates 102D.

Note that the shape of the main body portion 102B and how to dispose the dispersion plates 102D in a bridged manner are not limited to the above. For example, in a case where the main body portion 102B has a cylindrical shape, the dispersion plates 102D may be provided in a spiral manner along the inner wall of the cylindrical shape.

The dust collecting device 102C removes foreign matter included in the flowing gas, e.g., the core sand 200 or the like, from the flowing gas passing through the main body portion 102B and then discharges the flowing gas to outside the fluid heating furnace 100.

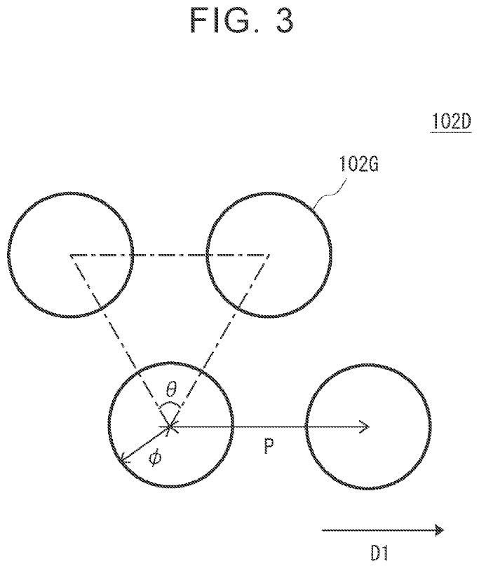

With reference to FIG. 3, the hole portions 102G provided in the dispersion plate 102D will be described. In the example illustrated in FIG. 3, the dispersion plate 102D is a punching metal provided with the hole portions 102G in a zigzag manner. More specifically, the dispersion plate 102D is provided with the hole portions 102G formed at predetermined pitches P along a first direction D1. Further, the hole portions 102G each have a circular shape with a predetermined radius ϕ. Further, three hole portions 102G adjacent to each other are placed at positions of vertexes of a triangular shape. More specifically, two hole portions 102G adjacent to each other along the first direction D1 and one hole portion 102G adjacent to the two hole portions 102G are placed at the positions of the vertexes of the triangular shape. Here, the angle of the corner, of the triangular shape, at which the one hole portion 102G adjacent to the two hole portions 102G adjacent to each other along the first direction D1 is referred to as θ. The triangular shape may be an isosceles triangle, or when θ is 60 degrees, the triangular shape is an equilateral triangle.

Note that the dispersion plate 102D may be a wire mesh having a plurality of hole portions with a predetermined magnitude.

Next will be described a heating method for heating the core sand 200 in the fluid heating furnace 100 according to Embodiment 1.

First, the core sand 200 is put into the main body portion 102B of the gas discharge passage 102 from the inlet portion 102A.

Subsequently, in the gas discharge passage 102, the flowing gas discharged through the gas discharge passage 102 heats the core sand 200 put into the gas discharge passage 102 from the inlet portion 102A. More specifically, inside the main body portion 102B, the flowing gas makes contact with the core sand 200, so that the flowing gas directly heats the core sand 200. Further, the core sand 200 is indirectly heated such that the core sand 200 makes contact with a wall portion of the main body portion 102B heated by the flowing gas or the dispersion plates 102D heated by the flowing gas.

Further, in the fluid tank 101, the core sand 200 heated in the gas discharge passage 102 is further heated.

### Example 1

Next will be described Example 1 of the present disclosure. As Example 1, heat exchange efficiency between the flowing gas and the core sand 200 in the main body portion 102B provided with the dispersion plates 102D was examined. Each of the dispersion plates 102D according to Example 1 was a punching metal provided with the hole portions 102G each having a radius ϕ of 5 mm, a pitch P of 8 mm, and an angle θ of 60° as illustrated in FIG. 3. Further, the number of the dispersion plates 102D provided inside the main body portion 102B of the gas discharge passage 102 was eight, the inclination angles of the dispersion plates 102D were 30 degrees on the basis of the horizontal direction, and the size of the gas discharge passage 102 was 30 cm in width, 21 cm in depth, and 150 cm in height. Further, as illustrated in FIG. 2, the eight dispersion plates 102D were disposed in a bridged manner inside the main body portion 102B at regular intervals such that the eight dispersion plates 102D were alternately inclined in different directions. Further, in Example 1, as the core sand 200, new sand and recycled sand of AC alumina sand (made by Hisagoya) and new sand and recycled sand of artificial spherical sand of green beads (made by KINSEI MATEC CO., LTD.) were used. Further, the temperature of the flowing gas to be supplied into the main body portion 102B from the lower side of the main body portion 102B was 340° C., and the flow rate of the flowing gas was 0.45 liters/m. Further, the temperature of the core sand 200 to be put into the main body portion 102B from the upper side of the main body portion 102B was 25° C., and the input amount of the core sand 200 was 165 kg/h. Further, in Example 1, the heat exchange efficiency was calculated based on Formula (1) as follows.

Heat Exchange Efficiency=((Sand Temperature after Heating−Sand Temperature before Heating)×Specific Heat of Sand)/Heat Input Amount×100 (1)

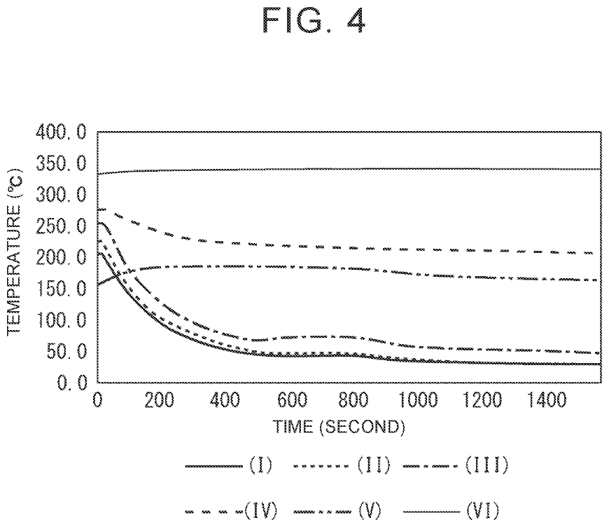

FIG. 4 illustrates temperatures of the flowing gas at various positions (positions P1 to P5 illustrated in FIG. 1) in the main body portion 102B and a temperature of the core sand 200 after the core sand 200 passed through the main body portion 102B (at a position P5 illustrated in FIG. 1) in Example 1. More specifically, the vertical axis in FIG. 4 indicates temperature (° C.), and the horizontal axis indicates time (second). Further, a symbol (I) described in the explanatory note in FIG. 4 indicates a temperature of the flowing gas discharged from the upper side of the main body portion 102B (the position P1 illustrated in FIG. 1), symbols (II) to (IV) indicate temperatures of the flowing gas at the positions P2 to P4 inside the main body portion 102B illustrated in FIG. 1, respectively, a symbol (V) indicates a temperature of the core sand 200 at the position P5 illustrated in FIG. 1, and a symbol (VI) indicates a temperature of the flowing gas (at the position P5 in FIG. 1) before entering of the flowing gas into the main body portion 102B from the upper side of the fluid tank 101. Note that data illustrated in FIG. 4 is data of the new sand of the green beads.

As illustrated in FIG. 4, the temperature (the symbol (VI)) of the flowing gas before entering of the flowing gas into the main body portion 102B from the upper side of the fluid tank 101 was around 340° C. Due to heat exchange between the flowing gas and the core sand 200 in the main body portion 102B, the temperature (the symbol (I)) of the flowing gas discharged from the main body portion 102B decreased to around 35° C. In the meantime, the temperature of the core sand 200 to be put into the main body portion 102B from the upper side of the main body portion 102B was 25° C. as described above, and the temperature (the symbol (V)) of the core sand 200 to be put into the fluid tank 101 through the main body portion 102B increased to around 150° C. It is found that the heat exchange efficiency between the flowing gas and the core sand 200 in the main body portion 102B was around 94% that is high efficiency.

In the fluid heating furnace 100 and the heating method according to Embodiment 1 described above, the core sand 200 from the inlet portion 102A of the gas discharge passage 102 is put into the fluid tank 101 through the gas discharge passage 102. Accordingly, the core sand 200 is heated by the flowing gas discharged through the gas discharge passage 102 before the core sand 200 reaches the fluid tank 101. Since heat is transmitted from the fluid gas to the core sand 200, the heat efficiency of the fluid heating furnace 100 is improved by just that much. Accordingly, it is possible to provide the fluid heating furnace 100 and the heating method each of which is improved in heat efficiency.

Further, the core sand 200 put in from the inlet portion 102A is dispersed by the plate-shaped dispersion plates 102D disposed in a bridged manner inside the main body portion 102B of the gas discharge passage 102 such that the dispersion plates 102D are inclined, the dispersion plates 102D having the hole portions 102G through which the core sand 200 can pass. On this account, the contact area of the core sand 200 with the flowing gas passing through the main body portion 102B increases, so that efficiency of heat exchange between the core sand 200 and the flowing gas improves.

Further, since the dispersion plates 102D are disposed in a bridged manner inside the main body portion 102B of the gas discharge passage 102, the core sand 200 is further dispersed, so that efficiency of heat exchange between the core sand 200 and the flowing gas further improves.

Further, the dispersion plates 102E, 102F inclined in different directions are provided inside the main body portion 102B. Hereby, the core sand 200 is further dispersed, so that efficiency of heat exchange between the core sand 200 and the flowing gas further improves.

Further, the dispersion plates 102E, 102F inclined in different directions are alternately disposed in a bridged manner over the inner walls of the main body portion 102B. Hereby, the core sand 200 is further dispersed, so that efficiency of heat exchange between the core sand 200 and the flowing gas further improves.

Further, the dispersion plates 102D are disposed in a bridged manner over the inner walls of the main body portion 102B at angles equal to or more than the angle of rest of the core sand 200. Hereby, it is possible to prevent the core sand 200 from staying on the dispersion plates 102D.

Note that the present disclosure is not limited to the above embodiment, and various modifications can be made appropriately within a range that does not deviate from the gist of the disclosure. For example, the dispersion plates 102D may be disposed in a bridged manner over the inner walls of the main body portion 102B at different angles in accordance with respective positions of the dispersion plates 102D inside the main body portion 102B. When the dispersion plates 102D are inclined at different angles, it is possible to change the time for the core sand 200 to pass on the dispersion plates 102D. For example, when the inclination angles of the dispersion plates 102D are set to become smaller from the lower side toward the upper side in the main body portion 102B, the time for the core sand 200 to make contact with the flowing gas the temperature of which is decreased is made longer in the upper side of the main body portion 102B, thereby making it possible to improve the heat exchange efficiency.

What is claimed is:

1. A fluid heating furnace for recycling core sand used for a core, the fluid heating furnace comprising:
a fluid tank in which the core sand is heated by flowing gas while the core sand is caused to flow by the flowing gas; and
a gas discharge passage communicating with the fluid tank such that the flowing gas is discharged through the gas discharge passage, wherein the gas discharge passage includes an inlet portion via which the core sand is put into the fluid tank through the gas discharge passage.

2. The fluid heating furnace according to claim 1, wherein the gas discharge passage includes
a tubular main body portion, and
a plate-shaped dispersion plate disposed in a bridged manner inside the main body portion such that the dispersion plate is inclined, the dispersion plate having a plurality of hole portions through which the core sand passes.

3. The fluid heating furnace according to claim 2, wherein the dispersion plate includes a plurality of dispersion plates disposed in a bridged manner inside the main body portion of the gas discharge passage.

4. The fluid heating furnace according to claim 3, wherein the dispersion plates are inclined in different directions.

5. The fluid heating furnace according to claim 4, wherein the dispersion plates inclined in the different directions are alternately disposed in a bridged manner inside the main body portion.

6. The fluid heating furnace according to claim 2, wherein the dispersion plate is inclined at an angle equal to or more than an angle of rest of the core sand.

7. A heating method for heating core sand used for a core by use of a fluid heating furnace including a fluid tank in which the core sand is heated by flowing gas while the core sand is caused to flow by the flowing gas, the fluid heating furnace further including a gas discharge passage communicating with the fluid tank such that the flowing gas is discharged through the gas discharge passage, the gas discharge passage including an inlet portion via which the core sand is put into the fluid tank through the gas discharge passage, the heating method comprising:
heating, in the gas discharge passage, the core sand put into the gas discharge passage from the inlet portion by the flowing gas discharged through the gas discharge passage; and
further heating, in the fluid tank, the core sand heated in the gas discharge passage.
